(19) United States
(12) Patent Application Publication
(10) Pub. No.: US 2023/0007168 A1
(43) Pub. Date: Jan. 5, 2023

(54) IMAGING APPARATUS, METHOD FOR CONTROLLING IMAGING APPARATUS, RECORDING MEDIUM, AND INFORMATION PROCESSING APPARATUS

(71) Applicant: CANON KABUSHIKI KAISHA, Tokyo (JP)

(72) Inventor: Masaki Kamba, Tokyo (JP)

(21) Appl. No.: 17/854,954

(22) Filed: Jun. 30, 2022

(30) Foreign Application Priority Data
Jul. 2, 2021 (JP) 2021-110512

(51) Int. Cl. H04N 5/232

(52) U.S. Cl. CPC H04N 5/23222; H04N 5/23219; H04N 5/232933

(57) ABSTRACT

A system control unit controls an imaging operation of an imaging unit based on an instruction from a user. Further, the system control unit detects a subject in an imaging range, The system control unit records the contents of the control of the operation of the imaging unit based on the instruction from the user in chronological order as operation information. The system control unit records information corresponding to a result of the detection of the subject in chronological order as detection information in association with the operation information. The system control unit reproduces the contents of the control of the operation of the imaging unit in chronological order based on the recorded operation information. Further, the system control unit controls a speed of the reproduction based on the recorded information.

### BACKGROUND OF THE DISCLOSURE

### Field of the Disclosure

The present disclosure relates to an imaging apparatus, a method for controlling an imaging apparatus, a recording medium, and an information processing apparatus.

### Description of the Related Art

As the market of streaming services has increased in recent years, various systems for imaging events such as weddings and lectures using imaging apparatuses (e.g., network cameras) capable of capturing moving images by remote control via a network have been developed. Particularly imaging apparatuses that can be operated remotely from a mobile terminal such as a smartphone or a personal computer (PC) by installing an application into the mobile terminal or the PC have been developed in recent years. An example of remote operations is pan/tilt/zoom (PTZ) operations of an imaging apparatus. Further, the imaging apparatuses include a preset function of controlling an angle of view to a preset angle of view and/or a trace function of reproducing an operation based on an operation received from a user at a subsequent time by recording information about the received operation. Japanese Patent No. 4745769 discusses an example of a technology for automatically tracking a subject by camera platform operations.

Meanwhile, in reproducing operations of an imaging apparatus under a situation where the operations of the imaging apparatus are controlled correspondingly to a movement of a subject using the trace function, the subject may not move in the same way as in the recording of the operations of the imaging apparatus. In this case, it is sometimes difficult to control the operations of the imaging apparatus correspondingly to the movement of the subject of interest as in the recording of the operations of the imaging apparatus in reproducing the operations of the imaging apparatus.

### SUMMARY OF THE DISCLOSURE

According to an aspect of the present disclosure, in order to reproduce a previously-performed imaging operation at a subsequent time in a more suitable form for a subject movement at that time, an imaging apparatus includes an imaging unit, a control unit configured to control an imaging operation of the imaging unit based on an instruction from a user, a detection unit configured to detect a subject in an imaging range of the imaging unit, a first recording unit configured to record contents of the control of the operation of the imaging unit based on the instruction from the user in chronological order as first information, a second recording unit configured to record information corresponding to a result of the detection of the subject in chronological order as second information in association with the first information, and a reproduction unit configured to reproduce the contents of the control of the operation of the imaging unit in chronological order based on the first information, wherein the reproduction unit controls a speed of the reproduction based on the second information.

Further features of the present disclosure will become apparent from the following description of exemplary embodiments with reference to the attached drawings.

### BRIEF DESCRIPTION OF THE DRAWINGS

FIG. 1 is a view illustrating an example of a system configuration of an imaging system.

FIG. 2 is a diagram illustrating an example of a configuration of an imaging apparatus.

FIG. 3 is a diagram illustrating an example of a configuration of a client apparatus.

FIG. 4 is a flowchart illustrating an example of a trace recording process.

FIG. 5 is a flowchart illustrating an example of a trace reproduction process.

FIG. 6 is a view illustrating an example of a use case of an imaging system.

FIGS. 7A and 7B are diagrams illustrating an example of a change in subject movement in trace reproduction.

FIGS. 8A and 8B are views illustrating an example of an angle of view of an imaging apparatus.

FIG. 9 is a flowchart illustrating an example of a process of an imaging system.

FIG. 10 is a flowchart illustrating an example of a process of an imaging system.

FIG. 11 is a view illustrating an example of a user interface (UI) of an imaging system.

FIG. 12 is a view illustrating an example of a UI of an imaging system.

### DESCRIPTION OF THE EMBODIMENTS

Various exemplary embodiments of the present disclosure will be described in detail below with reference to the attached drawings.

Components having substantially the same function and/or configuration are given the same reference numeral in the present specification and the drawings to omit redundant descriptions thereof.

### <System Configuration>

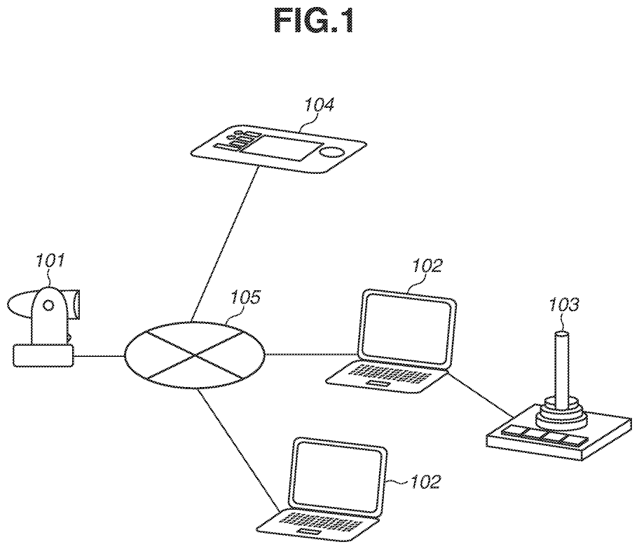

An example of a system configuration of an imaging system according to an exemplary embodiment of the present disclosure will be described below with reference to FIG. 1. The imaging system according to the present exemplary embodiment includes an imaging apparatus 101 and a terminal apparatus 102. The terminal apparatus 102 is used to control operations of the imaging apparatus 101. The imaging apparatus 101 and the terminal apparatus 102 are connected to transmit and receive information to and from each other via a network 105. Further, the plurality of terminal apparatuses 102 can be connected to the imaging apparatus 101 via the network 105. Further, a controller 104 can be applied in place of at least part of the terminal apparatuses 102. Further, an input apparatus 103 for receiving operations of controlling the operation of the imaging apparatus 101 from a user can be connected to at least part of the terminal apparatuses 102.

The imaging apparatus 101 can image portions in an imaging range based on an instruction from another apparatus (e.g., terminal apparatus 102, or controller 104) via the network 105. Further, the imaging apparatus 101 can control the imaging condition (e.g., focus, aperture, shutter speed, or gain) based on an instruction from another apparatus via the network 105. Further, the imaging apparatus 101 can transmit still image data and/or moving image data corresponding to imaging results to another apparatus based on an instruction from the other apparatus via the network 105. Hereinafter, unless specifically discriminated, a still image and a moving image are each referred to also as “image” for convenience.

Further, hereinafter, unless specifically discriminated, still image data and moving image data are each referred to also as “image data” for convenience.

The terminal apparatus 102 is realized by an information processing apparatus having a communication function, such as a personal computer (PC), a tablet terminal, or a smartphone. Further, the terminal apparatus 102 includes an output device, such as a display, and an input device, such as a touch panel. The output device presents information to the user, and the input apparatus receives instructions from the user. At least one of the output device and the input device can be realized as an external device attached to the terminal apparatus 102.

For example, the input apparatus 103 is an example of an external input device attached to the terminal apparatus 102. The input apparatus 103 can be connected to the terminal apparatus 102 via, for example, a universal serial bus (USB) or Bluetooth® transmission path. An input apparatus such as a joystick for realizing smooth pan/tilt/zoom (PTZ) operations that are difficult to realize singly with a graphical user interface (GUI) presented by an application can be applied to the input apparatus 103.

The controller 104 schematically illustrates hardware including an input interface for operating the imaging apparatus 101. While the controller 104 is connected to the imaging apparatus 101 via the network 105 in the example illustrated in FIG. 1, this is not necessarily intended to limit a connection method between the controller 104 and the imaging apparatus 101. Specifically, for example, the controller 104 can be connected to the imaging apparatus 101 using a connection method such as a serial connection.

The network 105 is not particularly limited and can be of any type via which the imaging apparatus 101 can establish communication with the terminal apparatus 102 and the controller 104. Specifically, for example, a network compliant with a communication standard such as Ethernet® can be applied to the network 105. In this case, the network 105 can be realized by a router, a switch, and a cable that are compliant with the communication standard. Further, as another example, a network that is compliant with a wireless communication standard such as Wi-Fi®, Bluetooth®, Long Term Evolution (LIE), or fifth generation (5G) can be applied to the network 105. Further, the network 105 can be realized by a plurality of networks. In this case, the plurality of networks can include two or more networks of different types from each other. Further, the imaging apparatus 101 can communicate with the terminal apparatus 102 and the controller 104 via another communication apparatus.

The configuration illustrated in FIG. 1 is a mere example and is not necessarily intended to limit the system configuration of the imaging system according to the present exemplary embodiment. Specifically, for example, the imaging apparatus 101 can be realized as a stand-alone apparatus. In this case, the imaging apparatus 101 can be provided with an input device for receiving instructions from the user and an output device for presenting information to the user. Further, even in this case, at least one of the input device and the output device can be realized as an external device attached to the imaging apparatus 101.

### <Configuration>

An example of a configuration of the imaging system according to the present exemplary embodiment will be described below with a focus on particularly each of the imaging apparatus 101 and the terminal apparatus 102.

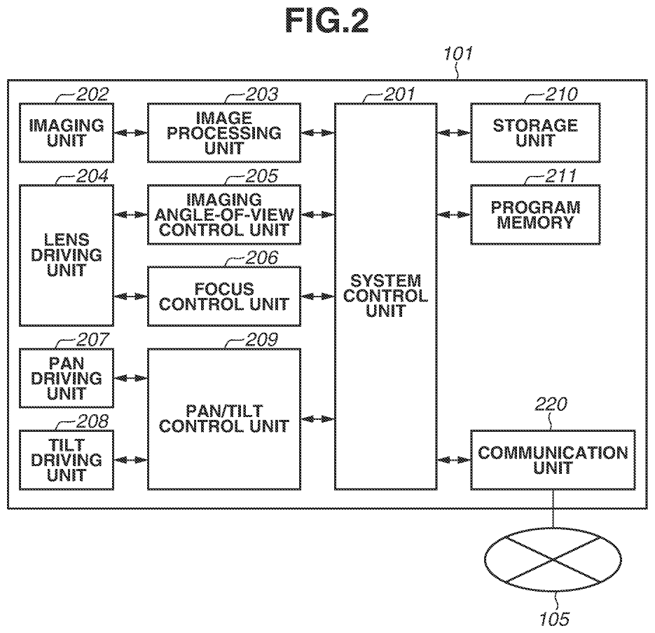

First, an example of a configuration of the imaging apparatus 101 will be described below with reference to FIG. 2. The imaging apparatus 101 includes a system control unit 201, an imaging unit 202, an image processing unit 203, a lens driving unit 204, an imaging angle-of-view control unit 205, a focus control unit 206, a pan driving unit 207, a tilt driving unit 208, and a pan/tilt control unit 209. Further, the imaging apparatus 101 can include a storage unit 210 and a program memory 211. Further, the imaging apparatus 101 can include a communication unit 220.

The system control unit 201 controls various operations (particularly, imaging operation) of the imaging apparatus 101 by instructing the components of the imaging apparatus 101. The system control unit 201 can be realized by an arithmetic device such as a central processing unit (CPU) or a microprocessor unit (MPU).

Further, the system control unit 201 can transmit and receive various types of information to and from other apparatuses (e.g., terminal apparatus 102) via the network 105 by controlling operations of the communication unit 220 described below. Specifically, for example, the system control unit 201 can receive a control command relating to imaging from the terminal apparatus 102 via the network 105 and analyze the control command to perform processing based on the control command. Hereinafter, the control command relating to imaging is also referred to as “camera control command” for convenience.

The camera control command includes a request command and a setting command. The request command is a command for requesting the imaging apparatus 101 to transmit image data and various setting values. The setting command is a command for specifying the setting values.

For example, the system control unit 201 can receive a request command for transmitting image data from the terminal apparatus 102. In this case, the system control unit 201 instructs the communication unit 220 to transmit image data generated by the image processing unit 203 to the terminal apparatus 102 via the network 105.

Further, as another example, the system control unit 201 can receive a request command for transmitting setting values relating to imaging, such as focus, zoom, pan, and tilt setting values, from the terminal apparatus 102. In this case, the system control unit 201 can acquire the setting values specified by the request command from components managing the specified setting values and can instruct the communication unit 220 to transmit the acquired information to the terminal apparatus 102 via the network 105. Examples of candidates for the components managing various setting values are the image processing unit 203, the imaging angle-of-view control unit 205, the focus control unit 206, and the pan/tilt control unit 209. Further, the system control unit 201 can transmit not only currently-set values but also, for example, settable range information about the values as setting value information relating to imaging to the terminal apparatus 102 via the network 105.

Further, the system control unit 201 can receive a setting command for specifying setting values relating to imaging from the terminal apparatus 102. In this case, the system control unit 201 instructs components corresponding to the setting values specified by the setting command to perform control based on the specified setting values. Examples of candidates for the components are the image processing unit 203, the imaging angle-of-view control unit 205, the focus control unit 206, and the pan/tilt control unit 209. Further, the control of operations of, for example, the imaging unit 202, the lens driving unit 204, the pan driving unit 207, and the tilt driving unit 208 by the components realizes the operation of the imaging apparatus 101 based on the setting values specified by the terminal apparatus 102.

The imaging unit 202 includes an imaging optical system, such as a lens, and an image sensor. An optical image (subject image) formed by the imaging optical system is guided to the image sensor and focused, and the image sensor photoelectrically converts the optical image into an electric signal. Then, for example, gain adjustment is performed on the electric signal (image signal) obtained by photoelectrically converting the optical image, and the resulting electric signal is converted from an analog signal to a digital signal by an analog/digital (A/D) converter. Then, the digital signal is output to the image processing unit 203.

The image processing unit 203 applies various types of image processing, resolution conversion processing, and compression encoding processing to the image signal output from the imaging unit 202 and generates image data. The image data generated by the image processing unit 203 can be stored in, for example, the storage unit 210 described below. Further, as another example, the image data can be transmitted to another apparatus (e.g., terminal apparatus 102) via the network 105 by the communication unit 220.

The lens driving unit 204 includes a driving system and a motor. The driving system controls positions of at least some of a series of optical members of the imaging optical system of the imaging unit 202. The motor is a driving source of the driving system. According to the present exemplary embodiment, the optical members that are a position control target of the lens driving unit 204 include an optical member for focus control (hereinafter, the optical member is also referred to as “focus lens”) and an optical member for angle-of-view control (hereinafter, the optical member is also referred to as “zoom lens”), Operations of the lens driving unit 204 are controlled by the imaging angle-of-view control unit 205 and the focus control unit 206.

The imaging angle-of-view control unit 205 instructs the lens driving unit 204 to control a position of the zoom lens based on zoom setting values output from the system control unit 201. Examples of the zoom setting values include a focal length setting value.

The focus control unit 206 instructs the lens driving unit 204 to control a position of the focus lens based on focus setting values output from the system control unit 201. The control of the position of the focus lens controls a position (focus position) on which the focus lens focuses in the imaging range.

At least some of the series of imaging operations of the imaging apparatus 101 can be controlled automatically based on various conditions such as an imaging environment.

Specifically, for example, in autofocusing (AF), an evaluation value is calculated from a contrast of an image based on a result of imaging by the imaging unit 202, and the focus control unit 206 controls the position of the focus lens based on the evaluation value. This controls the focus of the imaging unit 202 so that a subject in the imaging range is brought into focus.

Further, automatic control can be applied to not only the focus control but also, for example, exposure (aperture, shutter speed, gain, and neutral-density (ND) filter), white balance, noise reduction, and gamma control. These different types of automatic control can be performed by different components as appropriate. Specifically, for example, the noise reduction and the gamma control can be performed by the image processing unit 203.

The pan driving unit 207 includes a driving system and a motor. The driving system realizes a pan operation of controlling an imaging direction of the imaging unit 202 in a pan direction. The motor is a driving source of the driving system. Operations of the pan driving unit 207 are controlled by the pan/tilt control unit 209.

The tilt driving unit 208 includes a driving system and a motor. The driving system realizes a so-called tilt operation of controlling the imaging direction of the imaging unit 202 in a tilt direction. The motor is a driving source of the driving system. Operations of the tilt driving unit 208 are controlled by the pan/tilt control unit 209.

The pan/tilt control unit 209 instructs at least one of the pan driving unit 207 and the tilt driving unit 208 to control the imaging directions (control of pan/tilt operations) based on pan and tilt setting values output from the system control unit 201.

The storage unit 210 stores various types of data (e.g., image data) in at least one of an internal storage and an external storage. Further, the storage unit 210 can read various types of data stored in the internal storage and the external storage. The external storage and the internal storage can he realized by a non-volatile memory such as a hard disk drive (HDD) or a solid state drive (SDD).

The program memory 211 is a storage area for storing programs for controlling the operation of the imaging apparatus 101. The system control unit 201 realizes various operations of the imaging apparatus 101 by loading the programs stored in the program memory 211 and executing the loaded programs.

The communication unit 220 is a communication interface via which the components (e.g., system control unit 201) of the imaging apparatus 101 transmit and receive various types of information to and from other apparatuses (e.g., terminal apparatus 102) via the network 105. For example, the communication unit 220 can receive a camera control command from the terminal apparatus 102 via the network 105 and can output the camera control command to the system control unit 201. In this case, the communication unit 220 can transmit a response to the camera control command to the terminal apparatus 102 via the network 105 based on an instruction from the system control unit 201. The camera control command is as described above, so that redundant detailed descriptions thereof are omitted.

The configuration illustrated in FIG. 2 is a mere example and is not intended to limit the configuration of the imaging apparatus 101 according to the present exemplary embodiment. For example, the configuration illustrated in FIG. 2 can be realized by a plurality of devices cooperating together.

Specifically, for example, some of the components of the imaging apparatus 101 can be provided to another apparatus. Specifically, for example, the components corresponding to the system control unit 201, the storage unit 210, and the program memory 211 can he provided to another apparatus capable of transmitting and receiving information to and from the imaging apparatus 101 via a predetermined transmission path. In this case, the other apparatus corresponds to an example of an “information processing apparatus” that controls the operations of the imaging apparatus 101.

Further, as another example, processing loads of at least some of the components of the imaging apparatus 101 can be distributed to a plurality of apparatuses.

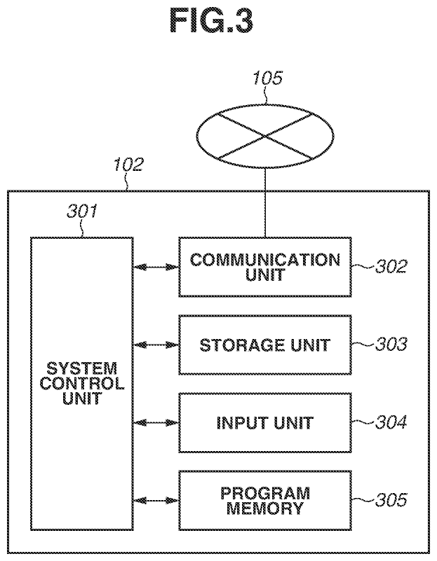

Next, an example of a configuration of a client apparatus will be described below with reference to FIG. 3. The client apparatus corresponds to an apparatus that is used to control the operations of the imaging apparatus 101, such as the terminal apparatus 102 and the controller 104. The client apparatus includes a system control unit 301, a communication unit 302, a storage unit 303, and a program memory 305. Further, the client apparatus can include an input unit 304.

The system control unit 301 controls various operations of the client apparatus by instructing the components of the client apparatus. The system control unit 301 can be realized by an arithmetic device such as a CPU.

For example, the system control unit 301 can generate a camera control command based on an operation received from the user by the input unit 304 and can instruct the communication unit 302 to transmit the camera control command to the imaging apparatus 101 via the network 105. With this system of transmitting the camera control command from the client apparatus to the imaging apparatus 101, the imaging apparatus 101 can be operated remotely through the client apparatus.

Further, the system control unit 301 can instruct the imaging apparatus 101 to record information about contents of control of an operation and to reproduce the operation (to reproduce the contents of the control) subsequently based on the recorded information. Hereinafter, the foregoing series of functions of recording the information about the contents of the control of the operation of the imaging apparatus 101 and reproducing the operation of the imaging apparatus 101 subsequently based on the information is also referred to as “trace function” for convenience. Further, the function of recording the information about the contents of the control of the operation of the imaging apparatus 101 in the trace function is also referred to as “trace recording”, and the function of reproducing the operation of the imaging apparatus 101 (reproducing the contents of the control) subsequently based on the recorded information is also referred to as “trace reproduction”.

Further, in a case where the communication unit 302 receives a response from the imaging apparatus 101, the system control unit 301 can analyze the response and perform processing based on the response.

The communication unit 302 is a communication interface via which the components (e.g., system control unit 301) of the client apparatus transmit and receive various types of information to and from other apparatuses (e.g., imaging apparatus 101) via the network 105. For example, the communication unit 302 can transmit a camera control command to the imaging apparatus 101 via the network 105 and can receive a response to the camera control command from the imaging apparatus 101. The camera control command is as described above, so that redundant detailed descriptions thereof are omitted.

The storage unit 303 stores various types of data (e.g., image data) in at least one of an internal storage and an external storage. Further, the storage unit 303 can read various types of data stored in the internal storage and the external storage. The external storage and the internal storage can be realized by a non-volatile memory such as a HDD or a SDD.

The program memory 305 is a storage area for storing programs (e.g., programs of various applications) for controlling operations of the client apparatus. The system control unit 301 realizes various operations of the client apparatus by loading the programs stored in the program memory 305 and executing the loaded programs.

The input unit 304 is an input interface for receiving instructions from the user.

The input unit 304 can be realized by input devices of the client apparatus, such as a button, a keyboard, a pointing device, and a joystick. Further, as another example, the input unit 304 can be realized by a touch panel of a display unit (not illustrated) such as a display.

The configuration illustrated in FIG. 3 is a mere example and is not intended to limit the configuration of the client apparatus according to the present exemplary embodiment.

For example, while the example illustrated in FIG. 3 does not include an illustration of a component corresponding to the display unit such as a display, the client apparatus can include a component corresponding to the display unit. With the component corresponding to the display unit of the client apparatus, for example, an image based on a result of imaging by the imaging apparatus 101 and a setting value applied to an imaging operation of the imaging apparatus 101 can be presented to the user.

Further, the configuration illustrated in FIG. 3 can be realized by a plurality of devices cooperating together.

Specifically, for example, some of the components of the client apparatus can be provided to another apparatus. Specifically, for example, the components corresponding to the input unit 304 and the storage unit 303 can be provided to another apparatus capable of transmitting and receiving information to and from the client apparatus via a predetermined transmission path.

Further, as another example, processing loads of at least some of the components of the client apparatus can be distributed to a plurality of apparatuses.

For convenience, a case where the terminal apparatus 102 is used as the client apparatus will be described below.

### COMPARATIVE EXAMPLE

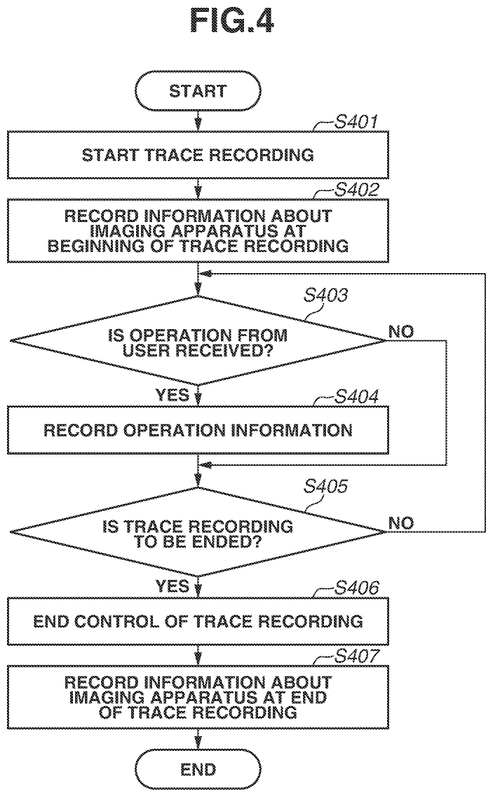

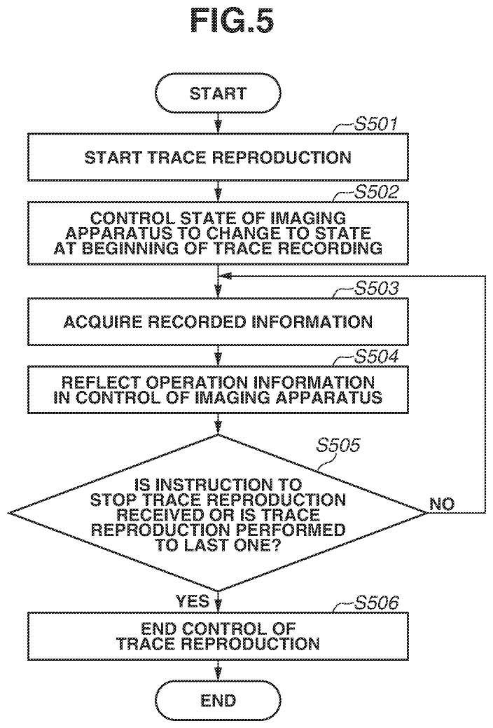

First, an example of a process for realizing the trace function will be described below with reference to FIGS. 4 and 5 as a comparative example to facilitate understanding of a feature of the imaging system according to the present exemplary embodiment.

First, an example of a process of the trace recording will be described below with reference to FIG. 4.

In step S401, the system control unit 201 of the imaging apparatus 101 starts a series of processes of the trace recording based on an instruction from the terminal apparatus 102.

First, in step S402, the system control unit 201 records information about a current state (e.g., imaging direction, and imaging condition) of the imaging apparatus 101 in a predetermined storage area at the beginning of the trace recording. Hereinafter, the information about the state of the imaging apparatus 101 is also referred to as “camera information” for convenience. Further, the storage unit 210 of the imaging apparatus 101 or the storage unit 303 of the terminal apparatus 102 can be used as the storage area. In a case where the storage unit 303 of the terminal apparatus 102 is used as the storage area, the system control unit 201 transmits the camera information to the terminal apparatus 102 via the network 105.

For convenience, a case where the storage unit 210 of the imaging apparatus 101 is used as the storage area will be described below.

In step S403, the system control unit 201 determines whether an operation from the user is received by the terminal apparatus 102 (i.e., whether an instruction from the user is received).

In a case where the system control unit 201 determines that an operation from the user is received by the terminal apparatus 102 (YES in step S403), the processing proceeds to step S404. In this case, in step S404, the system control unit 201 records information (hereinafter, also referred to as “operation information”) about the content of the operation received from the user by the terminal apparatus 102 in the storage unit 210 from the terminal apparatus 102 via the network 105. At this time, the system control unit 201 can record time information in association with the operation information.

On the other hand, in a case where the system control unit 201 determines that no operation from the user is received by the terminal apparatus 102 (NO in step S403), the processing proceeds to step S405. In this case, step S404 is skipped.

In step S405, the system control unit 201 determines whether to end the trace recording. Specifically, for example, the system control unit 201 can determine whether to end the trace recording based on whether an instruction to end the trace recording is received from the user.

In a case where the system control unit 201 determines not to end the trace recording (NO in step S405), the processing proceeds to step S403. In this case, step S403 and subsequent steps are performed again. As a result, the operation information is sequentially recorded in chronological order. Hereinafter, data of the operation information recorded sequentially in chronological order by the trace recording is also referred to as “trace data”.

On the other hand, in a case where the system control unit 201 determines to end the trace recording (YES in step S405), the processing proceeds to step S406.

In step S406, the system control unit 201 ends the control of the trace recording (e.g., control of the recording of the operation information).

Then, in step S407, the system control unit 201 records camera information about the state of the imaging apparatus 101 at the end of the trace recording in the storage unit 210, and then the process illustrated in FIG. 4 ends.

Next, an example of a process of the trace reproduction will be described below with reference to FIG. 5.

In step S501, the system control unit 201 of the imaging apparatus 101 starts a series of processes of the trace reproduction based on an instruction from the terminal apparatus 102.

In step S502, the system control unit 201 controls the state of the imaging apparatus 101 based on the camera information about the state of the imaging apparatus 101 at the beginning of the trace recording that is recorded in the storage unit 210 to change the state of the imaging apparatus 101 to the state at the beginning of the trace recording. As a result, the state of the imaging apparatus 101 (e.g., imaging direction, imaging condition) is substantially the same as the state at the beginning of the trace recording (at the time of performing step S402 in FIG. 4).

In step S503, the system control unit 201 acquires the trace data (i.e., operation information) recorded in the trace recording from the storage unit 210. At this time, the system control unit 201 acquires information recorded earlier among the information not having been acquired at this time point from the storage unit 210.

In step S504, the system control unit 201 controls operations of the imaging apparatus 101 based on the trace data (operation information) acquired in step S503.

In step S505, the system control unit 201 determines whether an instruction to stop the trace reproduction is received or the trace reproduction is performed to the last one of the series of pieces of information recorded in the trace recording.

In a case where the system control unit 201 determines that no instruction to stop the trace reproduction is received and the trace reproduction is not performed to the last (No in step S505), the processing proceeds to step S503. In this case, step S503 and subsequent steps are performed again on information not having been acquired by the process of step S503 among the information recorded in the storage unit 210 in the trace recording.

On the other hand, in a case where the system control unit 201 determines that an instruction to stop the trace reproduction is received or the trace reproduction is performed to the last (YES in step S505), the processing proceeds to step S506.

In step S506, the system control unit 201 ends the series of processes of the trace reproduction. As a result, the process illustrated in FIG. 5 is ended.

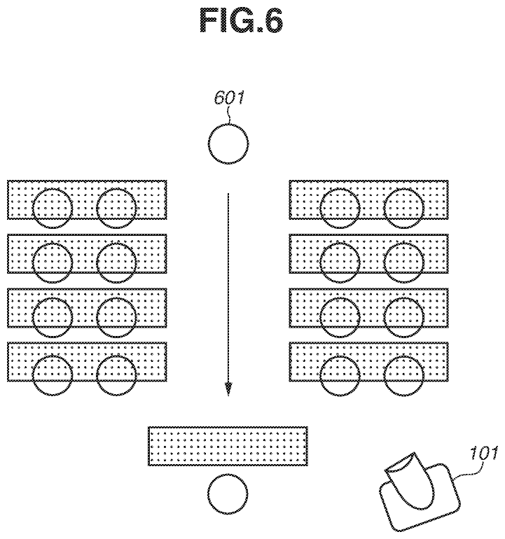

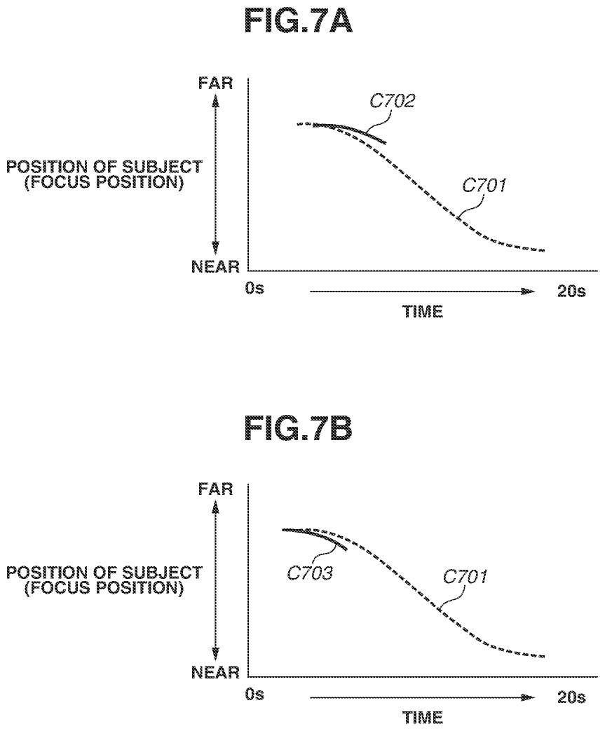

An outline of a technical issue of a case where an operation of the imaging apparatus 101 in the trace recording is reproduced using the trace function according to the comparative example will be described below with reference to FIGS. 6, 7A, and 7B.

For example, FIG. 6 is a view illustrating an example of a use case of the imaging system according to the present exemplary embodiment. FIG. 6 schematically illustrates a state of imaging a venue of a wedding by the imaging apparatus 101 during the wedding. In the example illustrated in FIG. 6, a scene where a person 601 as a main subject walks in a direction specified by an arrow is illustrated. The imaging apparatus 101 is situated to face the person 601, and various types of control including PTZ control and imaging control are performed by remote operations.

FIGS. 7A and 7B are graphs illustrating a transition of the position of the subject (i.e., subject movement) in the trace recording and a transition of the position of the subject in the trace reproduction in the scene illustrated in FIG. 6. In the examples illustrated in FIGS. 7A and 7B, a change in the focus position (the position on which the focus lens focuses in the imaging range) in a case where the subject is brought into focus by the autofocus control is illustrated as a transition of the position of the subject in chronological order. In each of the graphs illustrated in FIGS. 7A and 7B, a horizontal axis represents time whereas a vertical axis represents subject position (i.e., focus position) in a depth direction.

Each graph C701 in FIGS. 7A and 7B illustrates a transition of the position of the subject in the trace recording (i.e., a change in the position of the subject in chronological order). As illustrated by the graph C701, the person 601 as the subject moves towards the imaging apparatus 101 over time in the trace recording.

On the contrary, a graph C702 in FIG. 7A illustrates an example of a transition of the position of the subject in the trace reproduction. A comparison of the graph C702 with the graph C701 indicates that the chronological change in the position of the person 601 as the subject is slower in the trace reproduction than in the trace recording in the example illustrated in FIG. 7A.

Further, a graph C703 in FIG. 7B illustrates another example of a transition of the position of the subject in the trace reproduction. A comparison of the graph C703 with the graph C701 indicates that the chronological change in the position of the person 601 as the subject is faster in the trace reproduction than in the trace recording in the example illustrated in FIG. 7B.

As illustrated in FIGS. 7A and 7B, there are cases where the chronological change in the position of the subject in the trace recording and the chronological change in the position of the subject in the trace reproduction differ. Examples of a possible cause of the difference are a difference in speed of the movement of the subject between the trace recording and the trace reproduction and an effect of a gap in timing of starting the trace reproduction.

Considering the above-described situation, the imaging system according to the present exemplary embodiment records information (hereinafter, also referred to as “detection information”) corresponding to a subject detection result in the trace recording and controls the speed of the trace reproduction based on a difference between the recorded detection information and detection information in the trace reproduction.

Features of the imaging system according to the present exemplary embodiment will be described in more detail below.

### <Outline of Function>

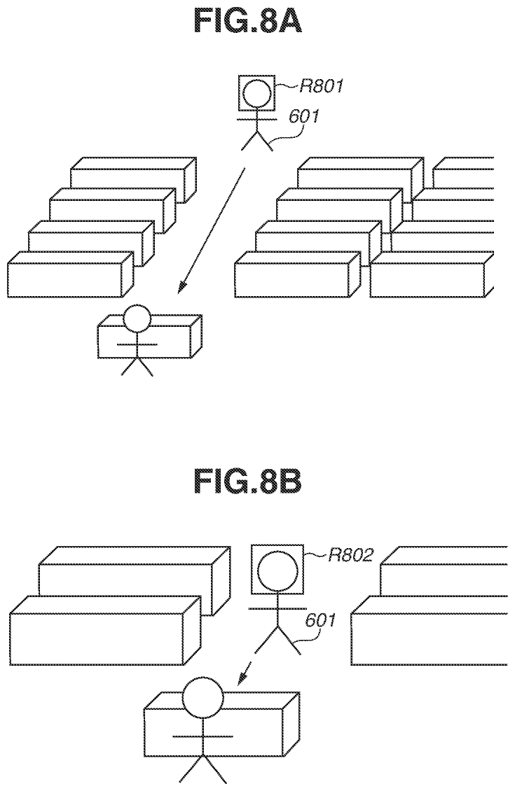

An outline of a function of controlling the speed of the trace reproduction of the imaging system according to the present exemplary embodiment will be described below with reference to FIGS. 8A and 8B. FIGS. 8A and 8B are views schematically illustrating an angle of view of the imaging apparatus 101 in the use case described above with reference to FIG. 6.

First, FIG. 8A will be described below. FIG. 8A schematically illustrates a situation where the angle of view is set to a wider angle to image a wider range of a scene immediately before the person 601 as the main subject starts walking in a direction specified by an arrow. A detection frame R801 schematically illustrates a detection frame presented based on a result of detecting a face of a person by a so-called face detection function. The detection frame R801 is managed based on, for example, coordinate information about a position at which a detection target is detected with respect to a current angle-of-view.

The coordinate information is not particularly limited and can be of any type that can specify a range of the detection frame R801 within the angle of view, Specifically, for example, in a case where the detection frame R801 is a rectangle, coordinates of upper-left and lower-right vertices of the rectangle can be managed as the coordinate information, or information about the coordinates of the upper-left vertex and height and width information can be managed as the coordinate information. A shape of the detection frame R801 is not particularly limited, and the type of the coordinate information can be changed appropriately for the shape.

Further, while the face of the person 601 as the main subject is a target of detection by the face detection function in the example illustrated in FIGS. 8A and 8B, functions for use in the detection are not particularly limited, and any functions that can detect a subject in the imaging range can be used. Specifically, for example, human body detection, moving object detection, and object detection functions can be used in subject detection. Further, detection target subjects are not limited to persons, and a function for use in detecting a detection target subject can be changed appropriately for the type of the detection target subject.

Next. FIG. 8B will be described below. FIG. 8B schematically illustrates a situation where a scene after the person 601 has moved forward in the arrow direction from the state illustrated in FIG. 8A is imaged at a zoomed-in angle of view to emphasize the person 601 as a main person (main subject). Similarly to the detection frame R801, a detection frame R802 schematically illustrates a detection frame presented based on a result of detecting a face of a person by the face detection function. In the scene illustrated in FIG. 8B, the person 601 is situated closer to the imaging apparatus 101 and, furthermore, zoom-in control is performed, compared to the scene illustrated in FIG. 8A. Thus, the detection frame R802 occupies a wider range in the angle of view than the detection frame R801 does. Specifically, the detection frame R802 is larger in size than the detection frame R801 due to effects of differences between the scenes and differences between the imaging conditions.

The imaging system according to the present exemplary embodiment records information about the contents of the control of the operation of the imaging apparatus 101 (e.g., contents of PTZ control and focus position control) in chronological order in association with detection information corresponding to the subject detection result described as an example with reference to FIGS. 8A and 8B in the trace recording. Further, the imaging system determines a difference in subject movement (e.g., whether the subject movement is faster or slower than the subject movement in the trace recording) by comparing the detection information corresponding to the subject detection result and the detection information recorded in the trace recording in the trace reproduction. Then, the imaging system controls the speed of reproducing the contents of the control of the operation of the imaging apparatus 101 in the trace reproduction based on a result of the determination of the difference in subject movement between the trace recording and the trace reproduction (e.g., the difference in transitions of the subject position).

Specifically, for example, in a case where the subject movement is slower than the subject movement in the trace recording, the imaging system can control the speed to reproduce the contents of the control of the operation of the imaging apparatus 101 at a decreased speed. Further, as another example, in a case where the subject movement is faster than the subject movement in the trace recording, the imaging system can control the speed to reproduce the contents of the control of the operation of the imaging apparatus 101 at an increased speed.

Application of the above-described control makes it possible to reproduce a previously-performed imaging operation of the imaging apparatus 101 (e.g., operation based on PTZ control and focus position control) at a subsequent time in a more suitable form for a subject movement at that time.

### <Process>

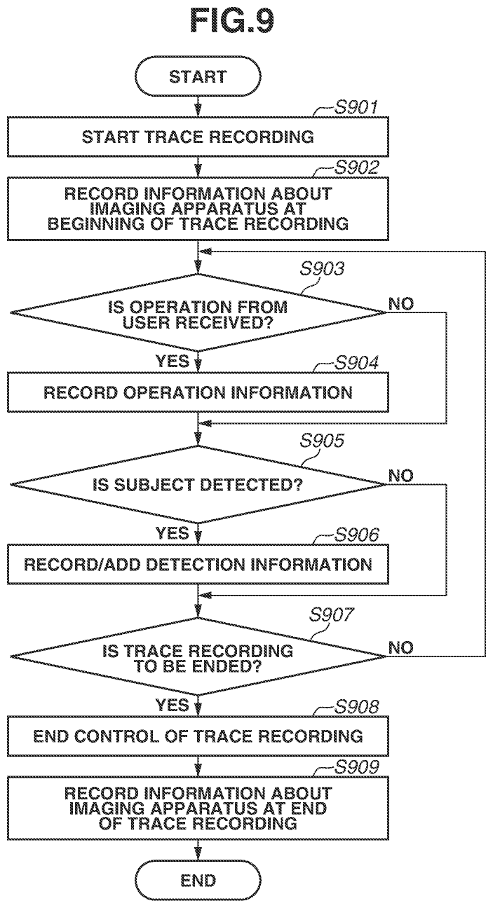

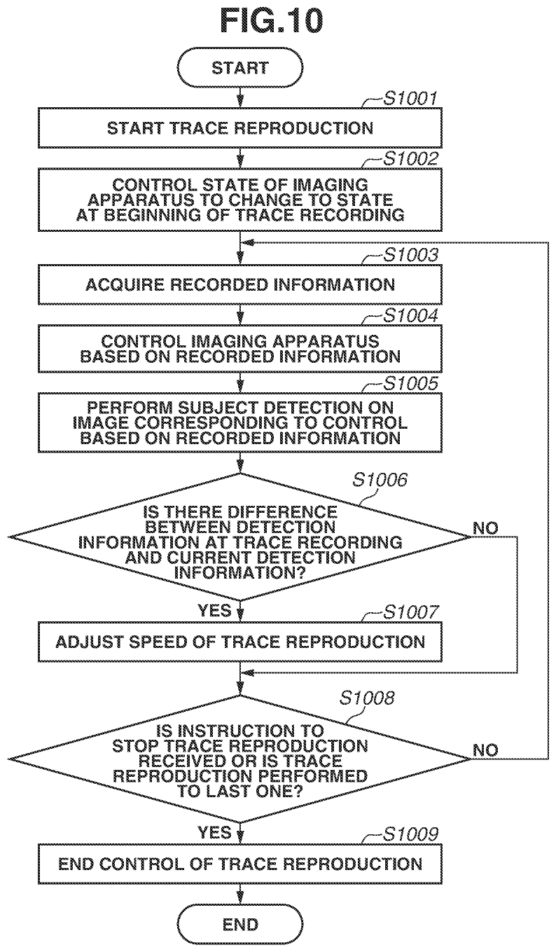

An example of a process of the imaging system according to the present exemplary embodiment will be described below with reference to FIGS. 9 and 10.

First, an example of a process of the trace recording will be described below with reference to FIG. 9. The example illustrated in FIG. 9 is different from the example illustrated in FIG. 4 in that a process for recording detection information is added. The following descriptions of the example illustrated in FIG. 9 focus particularly on differences from the example illustrated FIG. 4, and detailed descriptions of parts substantially similar to those of the example illustrated in FIG. 4 are omitted.

Steps S901 to S904 are substantially similar to steps S101 to S404 in FIG. 4. Specifically, the system control unit 201 of the imaging apparatus 101 records information about a current state of the imaging apparatus 101 at the beginning of the trace recording and thereafter records operation information about the content of an operation received from the user.

The operation information corresponds to an example of “first information”, and the process of recording the operation information that is described as step S904 corresponds to an example of “first recording process”.

In step S905, the system control unit 201 performs a process of detecting a subject in the imaging range of the imaging apparatus 101 and determines whether a subject (e.g., main subject) is detected. In detecting a subject, for example, a detection range can be preset. This makes it possible to limit a target of the subject detection to a subject of interest (e.g., main subject) among a series of subjects in the imaging range.

Further, as another example, some of a series of subjects detected by the subject detection can be selected as a main subject based on an instruction from the user.

In a case where the system control unit 201 determines that a subject is detected (YES in step S905), the processing proceeds to step S906. In step S906, the system control unit 201 records the detection information corresponding to the subject detection result in step S905 in the storage unit 210. The detection information includes, for example, information about a focus position at the time the subject is detected, a position of the detected subject, a distance to the detected subject, and a size of the detected subject. In a case where the operation information is recorded in step S904, the detection information is added following the operation information, and this associates the operation information with the detection information. Further, the detection information corresponds to an example of “second information”, and the process of recording the detection information that is described as step S906 corresponds to an example of “second recording process”.

On the other hand, in a case where the system control unit 201 determines that no subject is detected (NO in step S905), the processing proceeds to step S907. In this case, step S906 is skipped.

In step S907, the system control unit 201 determines whether to end the trace recording.

In a case where the system control unit 201 determines not to end the trace recording (NO in step S907), the processing proceeds to step S903. In this case, step S903 and subsequent steps are performed again. As a result, the operation information and the detection information are sequentially recorded in chronological order. According to the present exemplary embodiment, data of the operation information and the detection information that are recorded sequentially in chronological order by the trace recording corresponds to “trace data”.

On the other hand, in a case where the system control unit 201 determines to end the trace recording (YES in step S907), the processing proceeds to step S908.

In step S908, the system control unit 201 ends the control of the trace recording (e.g., the control of the recording of the operation information and the detection information).

Then, in step S909, the system control unit 201 records the camera information about the state of the imaging apparatus 101 at the end of the trace recording in the storage unit 210, and then the process in FIG. 9 ends.

Next, an example of a process of the trace reproduction will be described below with reference to FIG. 10. The example illustrated in FIG. 10 is different from the example illustrated in FIG. 5 in that a process for controlling the speed of reproducing the contents of the control of the operation of the imaging apparatus 101 based on the detection information is added. The following descriptions of the example illustrated in FIG. 10 focus particularly on differences from the example illustrated FIG. 5, and detailed descriptions of parts substantially similar to those of the example illustrated in FIG. 5 are omitted.

Steps S1001 to S1003 are substantially similar to steps S501 to S503 in FIG. 5. Specifically, at the beginning of the trace reproduction, the system control unit 201 of the imaging apparatus 101 controls the state of the imaging apparatus 101 based on the camera information at the beginning of the trace recording to change the state of the imaging apparatus 101 to the state at the beginning of the trace recording and acquires the trace data from the storage unit 210. In the trace data acquisition, the system control unit 201 acquires information recorded earlier among the information not having been acquired at this time point from the storage unit 210.

In step S1004, the system control unit 201 controls the operations of the imaging apparatus 101 (particularly, imaging operation) based on the trace data (e.g., operation information) acquired in step S1003.

Specifically, for example, the system control unit 201 can output information about the distance to the subject and information about the focus control (e.g., information about the focus position) to the focus control unit 206 among the information included in the trace data. The focus control unit 206 drives the lens driving unit 204 based on the information output from the system control unit 201 so that the focus control in the trace recording is reproduced.

Further, the system control unit 201 can output information about the pan control and the tilt control (e.g., information about positions in the pan and tilt directions) to the pan/tilt control unit 209 among the information included in the trace data. The pan/tilt control unit 209 drives the pan driving unit 207 and the tilt driving unit 208 based on the information output from the system control unit 201 so that the pan control and the tilt control in the trace recording are reproduced.

Further, the system control unit 201 can output information about the zoom control (e.g., zoom magnification information) to the imaging angle-of-view control unit 205 among the information included in the trace data. With the information, the imaging angle-of-view control unit 205 reproduces the zoom control in the trace recording.

Further, the system control unit 201 can output information about the image processing (e.g., information about image quality settings) to the image processing unit 203 among the information included in the trace data.

With the information, the image processing unit 203 applies the image processing to an image corresponding to a result of imaging by the imaging unit 202 based on a condition similar to that in the trace recording.

In step S1005, the system control unit 201 outputs the detection information included in the trace data to the image processing unit 203 and then instructs the image processing unit 203 to perform the subject detection process. The image processing unit 203 performs the process of detecting a subject from the image corresponding to the result of imaging by the imaging unit 202 based on the detection information output from the system control unit 201. This enables the image processing unit 203 to perform the process of detecting a subject from the image corresponding to the result of imaging by the imaging unit 202 based on a condition similar to that in the trace recording.

Specifically, for example, in a case where the subject detection range is limited in the trace recording, the image processing unit 203 limits the subject detection range as in the trace recording and then performs the subject detection process.

Further, as another example, in a case where some of the series of detected subjects are selected in the trace recording, the image processing unit 203 can select some of a series of subjects detected from the image based on a condition similar to that in the trace recording.

In step S1006, the image processing unit 203 compares the detection information corresponding to the result of the subject detection from the image corresponding to the result of imaging by the imaging unit 202 in step S1005 and the detection information recorded in the trace recording and notifies the system control unit 201 of the comparison result. The system control unit 201 determines whether there is a difference between the detection information in the trace recording and the current detection information (i.e., detection information in the trace reproduction) based on the detection information comparison result notified from the image processing unit 203. Specifically, for example, the system control unit 201 can determine whether there is a difference between the position at which the subject is detected, the size of the subject, the distance to the subject, and the focus position in the trace recording and those at the current time based on the detection information comparison result notified from the image processing unit 203.

In a case where the system control unit 201 determines that there is a difference between the pieces of detection information that are compared (YES in step S1006), the processing proceeds to step S1007. In step S1007, the system control unit 201 controls the speed of the trace reproduction, i.e., the speed of reproduction of the contents of the control of the operations of the imaging apparatus 101, based on the result of comparing the detection information in the trace recording and the current detection information in step S1006. Specifically, for example, the system control unit 201 can control the speed of the trace reproduction to reduce the difference in chronological transitions between the detection information in the trace recording and the current detection information.

A specific example of the control of the speed of the trace reproduction will be described below, focusing on a case where the speed of the trace reproduction is controlled to reduce the difference in chronological transitions between the detection information in the trace recording and the detection information in the trace reproduction.

For example, in a case where the speed of the chronological transition of the detection information in the trace reproduction is slower than the speed of the chronological transition of the detection information in the trace recording, the system control unit 201 can control the speed of the trace reproduction to a slower speed.

In this case, the system control unit 201 can realize more smooth trace reproduction by, for example, adding another new frame between a plurality of chronologically consecutive frames among a series of frames on which the trace data is recorded.

For example, the system control unit 201 can perform the trace reproduction after interpolating the contents of the control of the operations of the imaging apparatus 101 for the other frame based on the trace data corresponding to the previous frame and the trace data corresponding to the subsequent frame. Specifically, for example, the system control unit 201 can perform the trace reproduction after interpolating information about the imaging direction, the imaging range, and the focus control for the other frame based on the contents of the PTZ control and the focus position on the previous and subsequent frames. This makes it possible to maintain the frame rate by, for example, frame interpolation even in a case where the speed of the trace reproduction is decreased, so that the operations of the imaging apparatus 101 for the trace reproduction are controlled to be more smoothly.

Any methods can be used to interpolate the information (e.g., the contents of the control of the operations of the imaging apparatus 101) for adding the other frame. Specifically, for example, linear interpolation can be used. Further, as another example, the information can be interpolated based on the difference between the position at which the subject is detected in the previous frame of the frame to be added and the position at which the subject is detected in the subsequent frame of the frame to be added.

Further, as another example, the system control unit 201 can control the speed of the trace reproduction to a slower speed by inserting a wait period (e.g., a frame for stopping the trace reproduction) for temporarily stopping the trace reproduction between the consecutive frames.

As described above, the speed of the trace reproduction is controlled to a slower speed so that the relative speed of controlling the operations of the imaging unit 202 with respect to the speed of the subject moving at a speed slower than that in the trace recording substantially matches the speed in the trace recording. Specifically, for example, in a case where the an control is brought into focus and the speed of the subject movement is slower than the speed in the trace recording, the speed of swinging the imaging unit 202 in the pan direction is controlled to a slower speed corresponding to the speed of the subject. Specifically, the operations of the imaging unit 202 for the trace reproduction are controlled correspondingly to the movement of the subject moving at a speed slower than the speed in the trace recording so that a scene imaged in the trace recording and a scene imaged in the trace reproduction substantially match.

Further, in a case where the speed of the chronological transition of the detection information in the trace reproduction is faster than the speed of the chronological transition of the detection information in the trace recording, the system control unit 201 can control the speed of the trace reproduction to a faster speed.

In this case, the system control unit 201 can control the speed of the trace reproduction to a faster speed by, for example, skipping the control based on the trace data corresponding to some of the series of frames on which the trace data is recorded.

Further, as another example, the system control unit 201 can interpolate the contents of the control of the operations of the imaging apparatus 101 for subsequent frames based on differences in detection information between the pieces of trace data corresponding to the plurality of chronologically consecutive frames.

As described above, the speed of the trace reproduction is controlled to a faster speed so that the relative speed of the control of the operations of the imaging unit 202 with respect to the speed of the subject moving at a speed faster than the speed in the trace recording is controlled to substantially match the speed in the trace recording. Specifically, for example, in a case where the pan control is brought into focus and the speed of the subject movement is faster than the speed in the trace recording, the speed of swinging the imaging unit 202 in the pan direction is controlled to a faster speed correspondingly to the speed of the subject. Specifically, the operations of the imaging unit 202 for the trace reproduction are controlled correspondingly to the movement of the subject moving at a speed faster than the speed in the trace recording so that a scene imaged in the trace recording and a scene imaged in the trace reproduction substantially match.

The description of FIG. 10 will be resumed below.

In step S1008, the system control unit 201 determines whether an instruction to stop the trace reproduction is received or the trace reproduction is performed to the last one of the series of pieces of information recorded in the trace recording.

In a case where the system control unit 201 determines that no instruction to stop the trace reproduction is received and the trace reproduction is not performed to the last (NO in step S1008), the processing proceeds to step S1003. In this case, step S1003 and subsequent steps arc performed again on information not having been acquired by the process of step S1003 among the information recorded in the storage unit 210 in the trace recording.

On the other hand, in a case where the system control unit 201 determines that an instruction to stop the trace reproduction is received or the trace reproduction is performed to the last (YES in step S1008), the processing proceeds to step S1009.

In step S1009, the system control unit 201 ends the series of processes of the trace reproduction. As a result, the process illustrated in FIG. 10 ends.

While the processes of the trace recording and the trace reproduction are performed by the imaging apparatus 101 in the example described with reference to FIGS. 9 and 10, this is not necessarily intended to limit the processes of the imaging system according to the present exemplary embodiment. Specifically, for example, another apparatus such as the terminal apparatus 102 can perform the processes of the trace recording and the trace reproduction based on communication with the imaging apparatus 101 via the network 105. In this case, the trace data can be recorded in an internal storage or an external storage of the other apparatus.

Application of the above-described control makes it possible to reproduce the operation of the imaging apparatus 101 in the trace recording correspondingly to the subject movement in the trace reproduction even in a case where, for example, there is a difference between the speed of the subject movement in the trace recording and the speed of the subject movement in the trace reproduction. Specifically, the imaging system according to the present exemplary embodiment reproduces a previously-performed imaging operation at a subsequent time in a more suitable form for a subject movement at that time.

### MODIFIED EXAMPLE

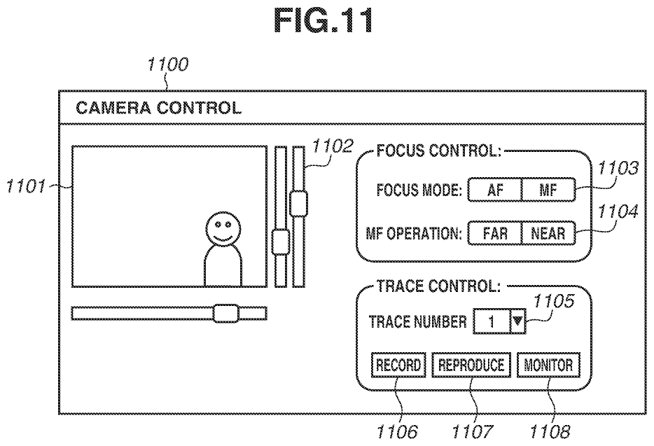

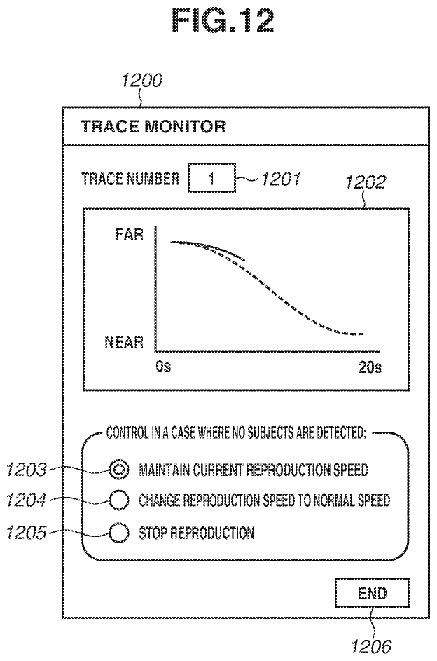

A modified example of the imaging system according to the present exemplary embodiment will be described below with reference to FIGS. 11 and 12. In the present modified example, an example of a system for presenting information for use in monitoring the control of the trace recording and the control of the trace reproduction by the user in performing the trace recording and the trace reproduction will be described below. The following descriptions of the imaging system according to the present modified example focus on differences from the imaging system according to the exemplary embodiment described above, and detailed descriptions of parts substantially similar to those of the imaging system according to the exemplary embodiment described above are omitted.

First, FIG. 11 will be described below. FIG. 11 illustrates an example of a user interface (UI) of the imaging system according to the present modified example. Specifically, an operation screen 1100 in FIG. 11 illustrates an example of a UI for receiving instructions for the control of the operations (particularly, imaging operation) of the imaging apparatus 101 from the user. The operation screen 1100 is presented to the user via an output unit of the terminal apparatus 102 through, for example, execution of a predetermined application by the terminal apparatus 102. The operation screen 1100 plays a role as an output interface for presenting images corresponding to results of imaging by the imaging apparatus 101 to the user and as an input interface for receiving instructions for operations (e.g., remote operation) of the imaging apparatus 101 from the user.

The operation screen 1100 includes an image display region 1101, a PTZ bar 1102, a focus mode operation section 1103, and a manual focus (MF) operation section 1104. Further, the operation screen 1100 includes, as a UI for the trace function, a trace number setting section 1105, a record button 1106, a reproduce button 1107, and a monitor button 1108.

The image display region 1101 is a display region for displaying an image corresponding to a result of imaging by the imaging apparatus 101. With the image displayed in the image display region 1101, the user can remotely operate the imaging apparatus 101 while checking the image.

The PTZ bar 1102 is an input interface for receiving instructions for the pan, tilt, and zoom control from the user.

The focus mode operation section 1103 is an input interface for receiving designation of an operation mode of the focus control from the user. In the example illustrated in FIG. 11, AF or MF can be selected as the operation mode of the focus control via the focus mode operation section 1103.

The MF operation section 1104 is an input interface for receiving instructions to adjust the focus position from the user in a case where the operation mode of the focus control is set to MF. In the example illustrated in FIG. 11, an input interface for controlling the focus position to a FAR direction and a NEAR direction is provided as the MF operation section 1104.

The PTZ bar 1102 and the focus mode operation section 1103 can be provided with a function of presenting values currently set for the imaging apparatus 101.

The trace number setting section 1105 is an input interface for receiving designation of identification information for identifying the trace data (operation information and detection information) that is a target of the trace recording, the trace reproduction, and a monitoring from the user. Hereinafter, the identification information is also referred to as “trace No.”.

The record button 1106 is an input interface for receiving instructions for the trace recording from the user. At the press of the record button 1106, the process of the trace recording described above with reference to FIG. 9 is started. Thereafter, at the press of the record button 1106, the started process of the trace recording ends. Then, the process of the trace recording is performed so that the trace number designated via the trace number setting section 1105 is assigned to the recorded trace data (operation information and detection information).

The reproduce button 1107 is an input interface for receiving instructions for the trace reproduction from the user. At the press of the reproduce button 1107, the process of the trace reproduction described above with reference to FIG. 10 is started based on the trace data (operation information and detection information) to which the trace number designated via the trace number setting section 1105 is assigned. Thereafter, at the press of the reproduce button 1107, the started process of the trace reproduction ends.

The monitor button 1108 is an input interface for receiving instructions from the user for presenting a UI via which the user checks the transition of the subject position in the trace recording based on the recorded trace data and the transition of the subject position in the trace reproduction. At the press of the monitor button 1108, a trace monitor screen 1200 illustrated in FIG. 12 is displayed to present the trace data with the trace number designated via the trace number setting section 1105 as information in the trace recording.

The trace monitor screen 1200 will be described below with reference to FIG. 12. The trace monitor screen 1200 is a screen used to present the status of the control of the trace reproduction (e.g., the control of the speed of the trace reproduction) by the imaging apparatus 101 to the user.

The trace monitor screen 1200 presents the following information to the user. Specifically, information indicating the transition of the subject position in the trace recording based on the detection information included in the trace data and information indicating the transition of the subject position detected in the trace reproduction based on the trace data are presented in chronological order to the user. Further, the trace monitor screen 1200 can receive instructions for control in a case where no subject is detected during the trace reproduction. The trace monitor screen 1200 includes a trace number display section 1201, a trace data display section 1202, radio buttons 1203 to 1205, and an end button 1206.

The trace number display section 1201 is a region where the trace number assigned to the trace data designated as the trace reproduction target is displayed. For example, the trace number display section 1201 displays the trace number designated via the trace number setting section 1105 of the operation screen 1100.

The trace data display section 1202 is a region where information about the transition of the subject position (i.e., subject movement) detected in the trace recording and information about the transition of the subject position detected in the trace reproduction are displayed. For example, in the example illustrated in FIG. 12, as in the example described above with reference to FIGS. 7A and 7B, the transition of the subject position in the trace recording and the transition of the subject position in the trace reproduction are graphed. Further, the information about the transition of the subject position in the trace recording is displayed based on the detection information included in the trace data designated as a monitoring target.

In the example illustrated in FIG. 12, in a case where the detection target subject moves in the trace reproduction as in the trace recording, the graph showing the transition of the subject position coincides with the graph showing the transition of the subject position in the trace recording. On the other hand, in a case where the movement of the detection target subject in the trace reproduction is different from the movement of the subject in the trace recording, the graph showing the transition of the subject position in the trace reproduction differs from the graph showing the transition of the subject position in the trace recording. Specifically, for example, in a case where the speed of the transition of the subject position in the trace reproduction is different from the speed of the transition of the subject position in the trace recording, a gap corresponding to the difference in speed may be formed between the graphs corresponding to the cases.

The imaging apparatus 101 monitors a difference between the transition of the subject position in the trace recording and the transition of the subject position in the trace reproduction, and in a case where there is a difference, the imaging apparatus 101 controls the speed of the trace reproduction. By applying the control, for example, the imaging apparatus 101 adjusts the transition of the subject transition of the subject position) in the angle of view in the trace reproduction so that the adjusted transition is closer to the transition of the subject in the angle of view in the trace recording. In other words, the imaging apparatus 101 applies the control so that a scene imaged during the trace reproduction becomes close to a scene imaged in the trace recording.

While not illustrated in FIG. 12, information (e.g., reproduction speed adjustment information) about the control of the speed of the trace reproduction by the imaging apparatus 101 can be displayed on the trace monitor screen 1200.

Candidate controls to be applied in a case where no subjects are detected in the trace reproduction are assigned to the radio buttons 1203 to 1205.

Specifically, for example, a control to maintain the speed of the trace reproduction at the current reproduction speed in a case where no subjects are detected is assigned to the radio button 1203.

Further, a control to change the speed of the trace reproduction to a reproduction speed preset as a default value in a case where no subjects are detected is assigned to the radio button 1204. Further, a control to stop the trace reproduction in a case where no subjects are detected is assigned to the radio button 1205. As to the control to stop the trace reproduction, a control to stop the series of operations of the trace reproduction can be applied, or a control to stop the trace reproduction temporarily until a subject is detected can be applied.

In a case where one of the radio buttons 1203 to 1205 is selected, the control assigned to the selected radio button is applied.

The end button 1206 is an input interface for receiving an instruction to end the monitoring of the status of the control of the trace reproduction by the imaging apparatus 101 from the user.

In a case where the end button 1206 is pressed, the series of processes of the monitoring ends, and the trace monitor screen 1200 is closed.

The above-described controls are applied so that in a case where there is a difference between the transition of the subject position in the trace reproduction and the transition of the subject position in the trace recording, the user can recognize the difference via the UI (trace monitor screen 1200).

Further, as described above, in a case where there is a difference between the subject detection result in the trace recording and the subject detection result in the trace reproduction, the imaging system according to the present exemplary embodiment performs the control of the speed of the trace reproduction to reduce the difference. Even in this case, feedback of the result of the control of the speed of the trace reproduction is provided to the UI. Thus, the user can recognize via the UI whether the control of the trace reproduction is performed in a suitable form for the subject movement in the trace reproduction.

### <Other Exemplary Embodiments>

The present disclosure can be realized also by the following process. Specifically, a program for realizing one or more functions of the above-described exemplary embodiments is supplied to a system or an apparatus via a network or a recording medium, and one or more processors of a computer of the system or the apparatus read the program and execute the read program. Further, the present disclosure can be realized also by a circuit (e.g., application-specific integrated circuit (ASIC)) that realizes one or more functions of the above-described exemplary embodiments.

According to each of the exemplary embodiments described above, a previously-performed imaging operation is reproduced at a subsequent time in a more suitable form for a subject movement at that time.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)?), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-110512, filed Jul. 2, 2021, which is hereby incorporated by reference herein in its entirety

What is claimed is:

1. An imaging apparatus comprising a processor executing instructions that, when executed by the processor, cause the processor to function as:
a control device configured to control an imaging unit;
a control unit configured to control an imaging operation of the imaging unit based on an instruction from a user;
a detection unit configured to detect a subject in an imaging range of the imaging unit;
a first recording unit configured to record contents of the control of the operation of the imaging unit based on the instruction from the user in chronological order as first information;
a second recording unit configured to record information corresponding to a result of the detection of the subject in chronological order as second information in association with the first information; and
a reproduction unit configured to reproduce the contents of the control of the operation of the imaging unit in chronological order based on the first information,
wherein the reproduction unit controls a speed of the reproduction based on the second information.

2. The imaging apparatus according to claim 1, wherein the detection unit detects the subject based on at least one of face detection, human body detection, moving object detection, or object detection.

3. The imaging apparatus according to claim 1, wherein the information corresponding to the result of the detection of the subject includes information about at least one of a focus position, a position of the detected subject, a distance to the detected subject, or a size of the detected subject.

4. The imaging apparatus according to claim 1, wherein the reproduction unit controls the speed of die reproduction to reduce a difference between a chronological transition of the information corresponding to the result of the detection of the subject in the reproduction and a chronological transition of the information corresponding to the result of the detection of the subject that is specified by the second information.

5. The imaging apparatus according to claim 4, wherein in a case where a speed of the chronological transition of the information corresponding to the result of the detection of the subject in the reproduction is slower than a speed of the chronological transition of the information corresponding to the result of the detection of the subject that is specified by the second information, the reproduction unit controls the speed of the reproduction to a slower speed.

6. The imaging apparatus according to claim 5, wherein the reproduction unit adds another frame into which at least one of the contents of the control of the operation of the imaging unit or the information about the subject is interpolated, the other frame inserted between a plurality of chronologically consecutive frames among a series of frames on which the second information is recorded based on pieces of the second information corresponding to the plurality of frames.

7. The imaging apparatus according to claim 4, wherein in a case where a speed of the chronological transition of the information corresponding to the result of the detection of the subject in the reproduction is faster than a speed of the chronological transition of the information corresponding to the result of the detection of the subject that is specified by the second information, the reproduction unit controls the speed of the reproduction to a faster speed.

8. The imaging apparatus according to claim 7, wherein the reproduction unit skips a control of the reproduction based on information corresponding to a frame that is included in information corresponding to a series of frames on which the second information is recorded.

9. A method for controlling an imaging apparatus, the method comprising:
controlling an imaging operation of an imaging unit based on an instruction from a user;
detecting a subject in an imaging range of the imaging unit;
recording, as first recording, contents of the control of the operation of the imaging unit based on the instruction from the user in chronological order as first information;
recording, as second recording, information corresponding to a result of the detection of the subject in chronological order as second information in association with the first information; and
reproducing the contents of the control of the operation of the imaging unit in chronological order based on the first information,
wherein a speed of the reproduction is controlled based on the second information.

10. A non-transitory computer-readable recording medium that stores a program for causing a computer to perform a method for controlling an imaging unit, the method comprising:
controlling an imaging operation of an imaging unit based on an instruction from a user;
detecting a subject in an imaging range of the imaging unit;
recording, as first recording, contents of the control of the operation of the imaging unit based on the instruction from the user in chronological order as first information;
recording, as second recording, information corresponding to a result of the detection of the subject in chronological order as second information in association with the first information; and
reproducing the contents of the control of the operation of the imaging unit chronological order based on the first information,
wherein a speed of the reproduction is controlled based on the second information.

11. An information processing apparatus comprising:
a first recording unit configured to record contents of a control of an operation of an imaging unit based on an instruction from a user in chronological order as first information;
a second recording unit configured to record information corresponding to a subject detection result in chronological order as second information in association with the first information; and
a reproduction unit configured to reproduce the contents of the control of the operation of the imaging unit in chronological order based on the first information,
wherein the reproduction unit controls a speed of the reproduction based on the second information.
